(19) United States
(12) Patent Application Publication
(10) Pub. No.: US 2013/0207472 A1
(43) Pub. Date: Aug. 15, 2013

(54) Extension USB Socket

(71) Applicant: Kuo-Ching CHIANG, New Taipei City (TW)

(72) Inventor: Kuo-Ching CHIANG, New Taipei City (TW)

(21) Appl. No.: 13/371,564

(22) Filed: Feb. 13, 2012

(51) Int. Cl. H02J 7/35

(52) U.S. Cl. 307/48

(57) ABSTRACT

A detachable extension USB socket for a portable device comprising: a cover housing for receiving a circuits; conducting pins coupled to said circuits and extending outside of said cover housing and said conducting pins being attachable from a wall socket; at least one USB port coupled to said conducting pins to allow an external device is charged from said wall socket through said least one USB port when a charging port of said external device is not match with said wall socket.

### TECHNICAL FIELD

The present invention relates, in general, to a USB socket for portable device, more particularly, to a detachable extension USB socket.

### BACKGROUND ART

Each device requires a power supply from a wall socket. The conventional type of wall socket is offered for conventional power supply specification. However, most of the portable device includes USB connector. Therefore, a great number of the portable devices cannot be charged by the conventional wall socket due to the wall socket is already set before the present of the USB specification. Currently, the user have to charge the cellular through the USB ports of the PC or notebook, certainly, PC or notebook has to be power-on. It is inconvenient to the user. FIG. 1 shows the conventional extension socket.

### SUMMARY

An object of the present invention is to provide a detachable extension USB socket for wall socket to allow the user may fetch the power supply from the old wall socket which cannot offer the USB connection.

The other object of the present invention is to provide wireless charging module, which is capable of providing sufficient electric power to the portable device by air.

In order to accomplish the above object, the present invention provides a detachable extension USB socket for a portable device comprising: a cover housing for receiving a circuits; conducting pins coupled to the circuits and extending outside of the cover housing and the conducting pins being extended outside of the cover housing to plug-into a wall socket, wherein the detachable extension USB socket is detachable from the wall socket and plug-into another wall socket; at least one USB port coupled to the conducting pins to allow an external device is charged from the wall socket through the least one USB port when a charging port of the external device is not match with the wall socket, wherein the at least one USB port is set on any surface with exception of a rear side of the detachable extension USB socket for providing a power supply connection for the external device to charge from the wall socket which fails to offer USB connection.

The detachable extension USB socket further comprises a solar cell array coupled to the circuits to charge the external device, wherein the solar cell array is provided so as to be exposed to an external environment for generating a voltage when light is received. A battery is coupled to the solar cell array. The detachable extension USB socket further comprises a wireless charging module coupled to the circuits to engage the external device for wireless charging the external device, the wireless charging is selected from inductive charging, radio charging, resonance charging, wherein the external device includes wireless power charging receiving module. Therefore, the user may choice to charge his device by USB connection or wireless charging module, no matter the wall socket is not matched with the device. The present invention is convenience to the travelers; it is because that the socket specification is different within various countries.

Alternatively, the detachable extension USB socket for a portable device comprises a cover housing for receiving circuits; conducting pins coupled to the circuits, and the conducting pins being extended outside of the cover housing to plug-into a wall socket, wherein the detachable extension USB socket is detachable from the wall socket and plug-into another wall socket; pluralities of USB ports arranged at surfaces of the cover housing coupled to the conducting pins to allow at least two external devices are charged from the wall socket through the pluralities of USB ports when charging ports of the external device is not match with the wall socket, wherein the pluralities of USB ports are set on with exception of surface having conducting pins of the detachable extension USB socket for providing a power supply connection for charging from the wall socket which fails to offer USB connection. In another embodiment, the detachable extension USB socket for a portable device comprises a cover housing for receiving circuits; conducting pins coupled to the circuits, and the conducting pins being extended outside of the cover housing to plug-into a wall socket, wherein the detachable extension USB socket is detachable from the wall socket and plug-into another wall socket; pluralities of USB ports arranged at surfaces of the cover housing coupled to the conducting pins to allow at least two external devices are charged from the wall socket through the pluralities of USB ports when charging ports of the external device is not match with the wall socket, wherein the pluralities of USB ports are set on different surfaces of the cover housing of the detachable extension USB socket to provide multi-directions engagement for power supply connection from the wall socket which fails to offer USB connection.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows the prior art.

FIG. 2 shows the appearance of an embodiment of the present invention.

FIG. 3 is a block diagram showing the appearance of an embodiment of the present invention.

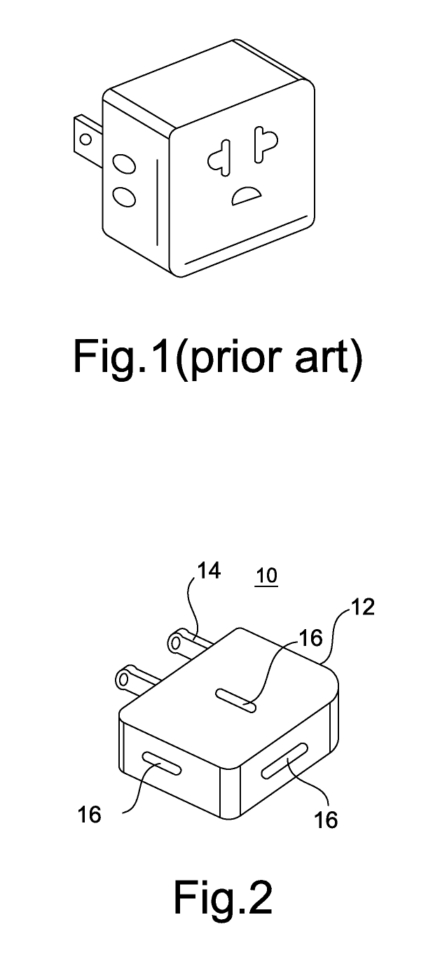

### DETAILED DESCRIPTION

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive. Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

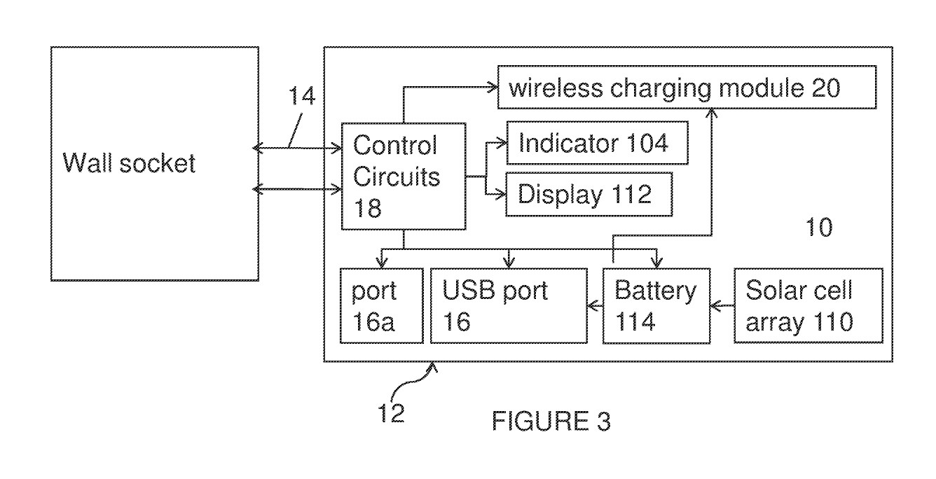

Please refer to FIGS. 2 and 3, the detachable extension multiport USB socket 10 of the present invention includes a cover housing 12 for receiving conducting pins 14 in the rear side of the detachable extension USB socket 10 and is extended outside of the housing to plug-into the associated wall socket. The detachable extension USB socket 10 maybe detached from the wall socket and plug-into any associated wall socket. At least one USB port 16 is set on any remaining surface with exception of the rear side of the detachable extension USB socket for providing the port for portable device to charge from the wall socket which fails to offer the USB socket. The at least one USB port 16 is coupled to the conducting pins 14 through circuits 18 for offer power to the portable device through the USB port of the detachable extension USB socket. A USB 16 is in connection with the pins 14 thereby creating an electrical connection for the external device and the wall socket. A part of the USB maybe extended outside the housing. The inner end is fastened into the inside of the housing. The aforementioned USB 16 could be A-type USB interface with a flat and wide shape, or B-type USB interface with a rectangular shape or a Mini-type USB interface with a flat and narrow shape. The portable device such as mobile phone, PDA, MP3, MP4 player, portable DVD, VCD, AP (access point), remoter, digital camera, tablet, smart phone or the like. Please refer to FIG. 3, a further connection port 16a which is different from the USB is also arranged to provide multiple type connection. The further connection port 16a may be a conventional port which is similar with the conventional wall socket instead of USB port. It means any ports 16 of the FIG. 2 can be altered by the connection port 16a. The further connection port 16a maybe fit with the conventional type socket. In another embodiment, the detachable extension USB socket 10 may include pluralities of USB ports are arranged at different surfaces of the housing 10 having six surfaces for providing multi-direction connection for the different external devices, as shown in FIG. 2. The detachable extension USB socket 10 includes wireless charger which includes a control unit 102 within the cover housing 12, a general purpose indicator 104 is coupled to the control unit 102 to indicate the status of the charging. A USB port 16 is coupled to the circuits 18 to allow the electricity power is charged into the device under charging. Typically, the USB port 16 is coulpled to the battery of the device or the power management unit of the device. A solar cell array (or solar cells) 110 maybe coupled to the battery 114 to receive the illumination. The charger may charge the battery 114 directly. Alternatively, the present invention may optionally include a battery 114 to store the electricity generated from the solar cell array or from the wall socket. The detachable extension USB socket 10 may charge a portable device through the battery 114. The wireless charger may includes a display 112 coupled to the circuits 18 to display status, date, time, temperature, moisture, information or the like. The display 112 and the indicator 104 are both optional element for the detachable extension USB socket 10.

The wireless charging module 20 which is coupled to the battery 114 or the circuits 18 may wireless engage to the external device through the air. The sensor of the device can sense whether the charging USB port 16 is coupled to the device or not. The wireless charging module 20 may provide the electricity power to the device 108 by wireless. Inductive charging uses an electromagnetic field to transfer energy between two objects. Energy is sent through inductive coupling to an electrical device, which then can use that energy to charge batteries. Because there is a small gap between the two coils employed in each of the sender and receiver of the energy within the respective devices, inductive charging is considered a short-distance “wireless” energy transfer, it frees the user from having to deal with wires between the two devices. This is advantageous for three reasons. Wireless charging is any of several methods of charging batteries without the use of cables or device-specific AC adaptors. Wireless charging can be used for a wide variety of devices including cell phones, laptop computers and MP3 players. There are three methods of wireless charging: inductive charging, radio charging and resonance charging. Inductive charging is used for charging mid-sized items such as cell phones, MP3 players and PDAs. In inductive charging, an adapter equipped with contact points is attached. Radio charging is used for charging items with small batteries and low power requirements, such as watches, hearing aids, medical implants, cell phones, MP3 players and wireless keyboard and mice. Radio waves are already in use to transmit and receive cellular telephone, television, radio and Wi-Fi signals. Wireless radio charging works similarly. Resonance charging is used for items that require large amounts of power, such as an electric car, robot, vacuum cleaner or laptop computer. In resonance charging, a copper coil attached to a power source is the sending unit. Another coil, attached to the device to be charged, is the receiver. Both coils are tuned to the same electromagnetic frequency, which makes it possible for energy to be transferred. Induction chargers typically use an induction coil to create an alternating electromagnetic field from within a charging base station, and a second induction coil in the portable device takes power from the electromagnetic field and converts it back into electrical current to charge the battery. The two induction coils in proximity combine to form an electrical transformer.

The problems mentioned in the background are solved. The wireless charger may be provided to any portable device such as portable phone, walkman, portable TV, portable DVD player, portable CD player, PDA, display, digital camera, GPS device, MP3, MP4 player, AP, remoter, notebook, palm computer or the like. In one case, the solar cell array can be attached on the outer surface of the detachable extension USB socket 10. The solar cell may be fabricated of one of various materials such as silicon (Si), gallium arsenide (GaAs), cadmium sulphide (CdS), indium phosphide (InP) and combinations thereof. However, the solar cell is preferably formed of silicon from cost reduction point of view. A booster circuit is needed for increasing the photo voltage to the electric source voltage of the portable device. The booster circuit could be formed in the charger side or the portable device side. Player includes an analog/digital (A/D) converter for converting analog audio signals into digital audio signals. The analog audio signals can come from an audio source coupled to player. A digital signal processor (DSP) or an audio and/or video driving module, for instance MP3, MP4 codec, are coupled to A/D converter to receive the digital audio signals. In one embodiment, MP3 or MP4 codec executes a firmware that includes a MPEG audio layer (e.g., MP3, MP2, or both) codec or video codec (e.g., MP4), and DSP executes a firmware that includes a different type of audio codec (e.g., WMA, ACC, or both). In one embodiment, the firmware for DSP also includes a video codec for encoding and decoding videos (e.g., MPEG-4 V1/V2/V3, DivX 3.11/4.0/5.0, Xvid, AVI/ASF, or any combination thereof). MP3 (or MP4) codec and DSP are coupled to a nonvolatile memory that stores the compressed audio data. The user can select an audio file from nonvolatile memory. DSPs and are coupled to an audio processor, which processes the digital audio signals according to default settings or user instructions. Audio processor is coupled to a digital/analog (D/A) converter, which converts the digital audio signals into analog audio signals for the user. A display is coupled to the DSP. The electricity generated by the solar cell may be supplied from the solar cell to the battery through contacts or a flexible cable. The voltage generated by the solar cell is greater than a predetermined voltage, the solar cell is rendered not to supply electricity to the battery by a semiconductor relay. A converter is coupled to the processor for converting the data between digital and analog. An audio I/O unit is coupled to the converter for audio signal input and output. Meanwhile, according to the present invention, since the battery is charged by the solar cell from time to time, a lithium-ion battery without a memory effect or the other conventional batteries having such characteristics may be preferably utilized for the mobile terminal of the present invention. The portable device includes but not limited to cordless phone, a Portable Digital Assistant (PDA), a palmtop computer, MP3 player, MP4 player, camera or the like.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A detachable extension USB socket for a portable device comprising:
a cover housing for receiving circuits;
conducting pins coupled to said circuits, and said conducting pins being extended outside of said cover housing to plug-into a wall socket, wherein said detachable extension USB socket is detachable from said wall socket and plug-into another wall socket; at least one USB port coupled to said conducting pins to allow an external device is charged from said wall socket through said least one USB port when a charging port of said external device is not match with said wall socket, wherein said at least one USB port is set on any surface with exception of surface having conducting pins of said detachable extension USB socket for providing a power supply connection for said external device to charge from said wall socket which fails to offer USB connection.

2. The detachable extension USB socket of claim 1, further comprising a solar cell array coupled to said circuits to charge said external device, wherein said solar cell array is provided so as to be exposed to an external environment for generating a voltage when light is received.

3. The detachable extension USB socket of claim 2, further comprising a battery coupled to said solar cell array.

4. The detachable extension USB socket of claim 1, further comprising a wireless charging module coupled to said circuits to engage said external device for wireless charging said external device, said wireless charging is selected from inductive charging, radio charging, resonance charging, wherein said external device includes wireless power charging receiving module.

5. The detachable extension USB socket of claim 4, further comprising a solar cell array coupled to said circuits to charge said external device, wherein said solar cell array is provided so as to be exposed to an external environment for generating a voltage when light is received.

6. The detachable extension USB socket of claim 5, further comprising a battery coupled to said solar cell array.

7. A detachable extension USB socket for a portable device comprising:
a cover housing for receiving circuits;
conducting pins coupled to said circuits, and said conducting pins being extended outside of said cover housing to plug-into a wall socket, wherein said detachable extension USB socket is detachable from said wall socket and plug-into another wall socket; pluralities of USB ports arranged at surfaces of said cover housing coupled to said conducting pins to allow at least two external devices are charged from said wall socket through said pluralities of USB ports when charging ports of said external device is not match with said wall socket, wherein said pluralities of USB ports are set on with exception of surface having conducting pins of said detachable extension USB socket for providing a power supply connection for charging from said wall socket which fails to offer USB connection.

8. The detachable extension USB socket of claim 7, further comprising a solar cell array coupled to said circuits to charge said external device, wherein said solar cell array is provided so as to be exposed to an external environment for generating a voltage when light is received.

9. The detachable extension USB socket of claim 8, further comprising a battery coupled to said solar cell array.

10. The detachable extension USB socket of claim 7, further comprising a wireless charging module coupled to said circuits to engage said external device for wireless charging said external device, said wireless charging is selected from inductive charging, radio charging, resonance charging, wherein said external device includes wireless power charging receiving module.

11. The detachable extension USB socket of claim 7, wherein said pluralities of USB ports includes a first type USB port and a second type USB port which is different from said first type USB port.

12. A detachable extension USB socket for a portable device comprising:
a cover housing for receiving circuits;
conducting pins coupled to said circuits, and said conducting pins being extended outside of said cover housing to plug-into a wall socket, wherein said detachable extension USB socket is detachable from said wall socket and plug-into another wall socket; pluralities of USB ports arranged at surfaces of said cover housing coupled to said conducting pins to allow at least two external devices are charged from said wall socket through said pluralities of USB ports when charging ports of said external device is not match with said wall socket, wherein said pluralities of USB ports are set on different surfaces of said cover housing of said detachable extension USB socket to provide multi-directions engagement for power supply connection from said wall socket which fails to offer USB connection.

13. The detachable extension USB socket of claim 12, further comprising a solar cell array coupled to said circuits to charge said external device, wherein said solar cell array is provided so as to be exposed to an external environment for generating a voltage when light is received.

14. The detachable extension USB socket of claim 13, further comprising a battery coupled to said solar cell array.

15. The detachable extension USB socket of claim 12, further comprising a wireless charging module coupled to said circuits to engage said external device for wireless charging said external device, said wireless charging is selected from inductive charging, radio charging, resonance charging, wherein said external device includes wireless power charging receiving module.
